(19) United States
(12) Patent Application Publication
(10) Pub. No.: US 2006/0061339 A1
(43) Pub. Date: Mar. 23, 2006

(54) Temperature regulator for a multiphase voltage regulator

(75) Inventors: Thomas Francis Lewis, Raleigh, NC (US); Kevin Shayne Dwayne Vernon, Durham, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/920,126

(22) Filed: Aug. 17, 2004

(51) Int. Cl. G05F 1/40

(52) U.S. Cl. 323/237

(57) ABSTRACT

A multiphase voltage regulator automatically senses the temperature of components from each phase and lowers the current through hot phases while raising the current through cool phases. Dynamic adjustments of current outputs from the various phases of the multiphase regulator allows adaptability to any change in cooling characteristics of the voltage regulator. Dynamically varying outputs from phases provides a load with a constant current while preventing heat damage to system components.

### TECHNICAL FIELD

The present invention relates in general to a system for regulating temperature by controlling currents in a multiphase voltage regulator.

### BACKGROUND INFORMATION

A trend in personal computers (PCs) is to provide increased performance from a smaller computer chassis. Increased performance is often achieved by increasing the clock frequency of the central processing unit (CPU). Increased clock frequencies add to performance but require more power and produce more heat. The heat generated is harder to dissipate from a smaller computer chassis because components are packed tighter, cooling components are necessarily limited in size, and the amount of cooling air in the smaller chassis is decreased. Therefore, a smaller chassis makes it more difficult to dissipate the heat generated by various computer components such as the voltage regulator. As a result, PC design requires advanced thinking in cooling as clock speed increases and chassis size decreases.

Today a common method of cooling the CPU and voltage regulator is by using a heatsink with a fan. This method was acceptable when customers were not as concerned with system noise and when the power demand was not as great. As the power demanded by the processor increases, the RPMs of the fan must increase to properly cool the system. This increase in RPMs causes a corresponding increase in system noise, which could become intolerable. System designers are often required to meet acoustic level specifications before shipping computer systems. The use of active cooling with only a fan makes it a challenge to meet the acoustic level specifications.

For customers requiring small systems with fast processors, the challenge for a system designer is to incorporate a high-speed processor in a small chassis without sacrificing performance by throttling the processor. Because of the high power demanded by such processors, the temperatures of some components within the voltage regulator circuit reach a critical limit that causes the printed circuit board (PCB) to become discolored and other components to get damaged. Such problems lead to failure of the system, which in turn leads to warranty claims by customers and a decrease in customer satisfaction.

In an ideal world in which acoustic levels, cost, and space were not issues, devices such as fans, heat-pipes, refrigerants, and heatsinks could be used to cool processors and other components. Another solution is the use of “static current imbalance.” Static current imbalance is a way of imbalancing the currents flowing through different phases of a multiphase voltage regulator. If one phase is prone to build up heat, a system designer can decrease the current in that phase and increase the current in another phase of the multiphase voltage regulator. A drawback to such a method is that a system designer is required to determine in advance where the hot-spots might be in order to set up a current imbalance. If the location of the hot-spots changes due to, for example, a cable blocking air flow to a phase of the voltage regulator, that phase could build up heat and cause damage to system components. Therefore, what is needed is a system for automatically and dynamically changing the current balance in phases of a multiphase voltage regulator to provide a more robust system for managing the heat from such multiphase voltage regulators.

### SUMMARY OF THE INVENTION

The present invention addresses the foregoing need by providing a dynamic method for preventing the buildup of heat within a phase of a multiphase voltage regulator by steering current from hot phases to cooler phases. In an embodiment of the present invention, the temperatures of components from multiple phases are sensed. The temperatures are compared to set points. The system determines which phase is the hottest and which phase is the coolest. If any phase reaches a set point, current is steered from that phase to a cooler phase.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention and the advantages thereof, refer to the following descriptions and the accompanying drawings, in which:

FIG. 1 illustrates a representative hardware environment for practicing the present invention;

FIG. 2 illustrates a multiphase voltage regulator for providing current and voltage to a load such as a CPU;

FIG. 3 illustrates representative steps taken by an embodiment of the present invention; and

FIG. 4 illustrates a schematic of an embodiment of the present invention.

### DETAILED DESCRIPTION

In the following description, well-known circuits have been shown in block diagram form in order not to obscure the present invention in unnecessary detail. Other details have been omitted inasmuch as such details are not necessary to obtain a complete understanding of the present invention and are within the skills of persons of ordinary skill in the relevant art.

The present invention provides an alternative approach to preventing voltage regulator components from reaching a critical temperature that could lead to permanent discoloration of the PCB and component failure. In the layout, of many systems, some components may become obstructed from airflow and thus will operate at higher temperatures than other components. Such effects become more pronounced as systems become smaller. As a result of the way fans in today's computer systems are controlled, there are times when various phases in the voltage regulator circuit operate at higher temperatures than others. What is more, the operating temperatures within the phases of a voltage regulator may change from time to time. This is especially true if an object such as a cable slips into the path of the airflow of a phase or a foreign object stops the fan from spinning. A system for automatically preventing a buildup of heat in components is needed to account for changing needs of a computer system.

The present invention provides a system of monitoring the temperatures within the phases of the converter and dynamically steering more current to the cooler phase(s). This steering could be done automatically and on-the-fly without affecting system performance. The computer user would likely be unaware of changes made as part of the present invention. In an embodiment of the present invention, the temperature of each phase of the voltage regulator is measured and currents from the hottest phases are dynamically steered toward cooler phases. Steering current from hot phases reduces the rate at which heat builds up in that phase and allows thermal energy to dissipate into the surrounding environment.

When the temperature of a phase gets within a threshold of the set point, some of the current from that phase can be dynamically steered to a cooler phase. This shift in current does not affect the maximum current provided by the voltage regulator but allows the phase that was running hot to be cooled by diverting its current to other phase(s).

The modem multiphase voltage regulators provide a method of sensing the output current in each phase. The regulators provide closed-loop control generally designed to equalize the average current flowing through each phase. Resistors are provided in a feedback path to sense the current flowing through each phase. Equal resistor values in each phase provide equal current flow through each phase. With static current imbalance methods, the resistor values can be adjusted during the design phase to provide unequal current in each phase. The drawback to this approach is that the resistor values are static. The resister values are determined during initial board design and are not changed if the temperature profile of the system changes over time.

The present invention does not have the same limitations for adjusting the resistor values only during the design phase. An embodiment of the present invention allows for continuous, real-time, automatic monitoring of a phase component's temperature and dynamic adjustment of the current through that phase. Because the current through a component directly relates to the temperature of the component, adjusting the current also adjusts the component's temperature.

Refer now to the drawings wherein depicted elements are not necessarily shown to scale and wherein like or similar elements are designated by the same reference numeral through the several views.

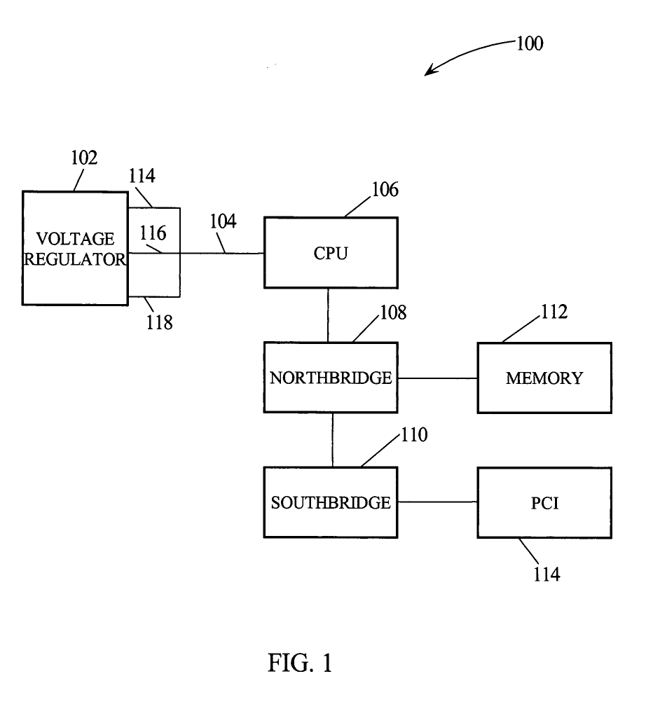

FIG. 1 illustrates a representative hardware environment for practicing the present invention. Item 100 represents a motherboard architecture including a multiphase voltage regulator 102 and a CPU 106. Voltage regulator 102 includes phases 114, 116, and 118 for carrying current to CPU 106 over line 104. To provide context to an embodiment of the present invention, FIG. 1 illustrates northbridge 108, memory 112, southbridge 110, and PCI 114 as part of motherboard architecture 100.

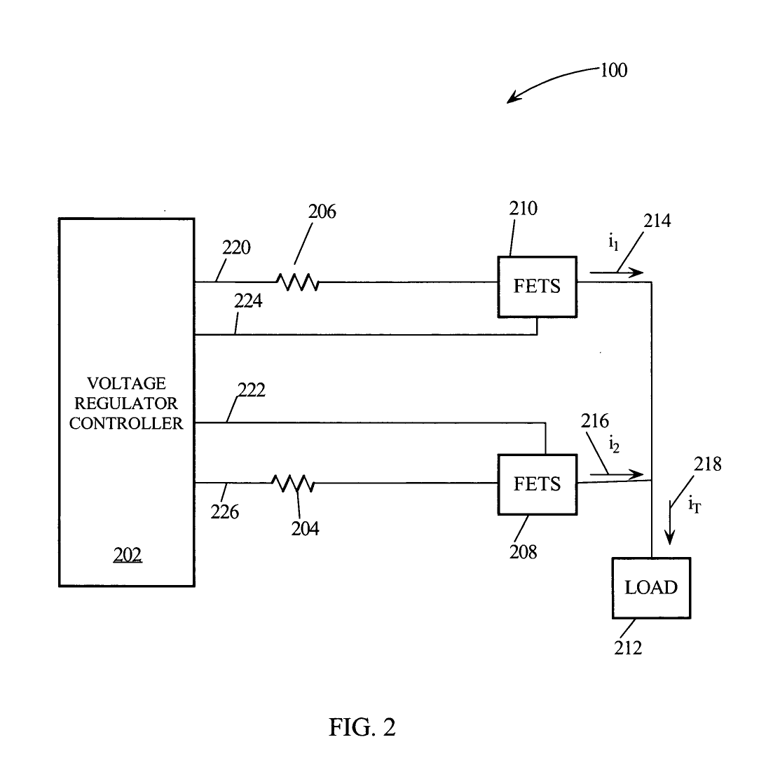

FIG. 2 is a schematic showing a voltage regulator 200 for providing a voltage and current to load 212. Voltage regulator 202 could be a regulator 102 for providing power to CPU 106 as shown in FIG. 1. Voltage regulator controller 202 includes two signals from 224 and 222 for controlling the output current of FETs 210 and 208. FETs 210 and 208 could be a bank of field effect transistors and associated components for providing output currents 214 and 216 based on control signals 224 and 222. Through pins 220 and 226, voltage regulator controller 202 receives feedback signals for controlling outputs from pins 224 and 222. Resistors 206 and 204 may be referred to as “sense resistors.” The values of sense resistors 204 and 206 affect the signals received at pins 220 and 226. In turn, controller 202 determines the levels of currents 214 and 216 by adjusting signals from pins 224 and 222. Currents 214 and 216 combine to provide load 212 with current 218. If the value of resistors 206 and 204 are equal, voltage regulator controller 202 is designed to use signals from 224 and 222 to produce equal currents 214 and 216 from FETs 210 and FETs 208. However, the values for resistors 206 and 204 can be adjusted during the design phase to provide unequal values for currents 214 and 216. The drawback to this approach is that the values for resistors 206 and 204 are static. The values of resistors 204 and 206 are chosen during the initial design of motherboard 100 and cannot be changed as the temperature profile of the system changes over time. What is needed is an improved system for changing the currents provided by each phase in the voltage regulator circuit by changing feedback to pins 220 and 226.

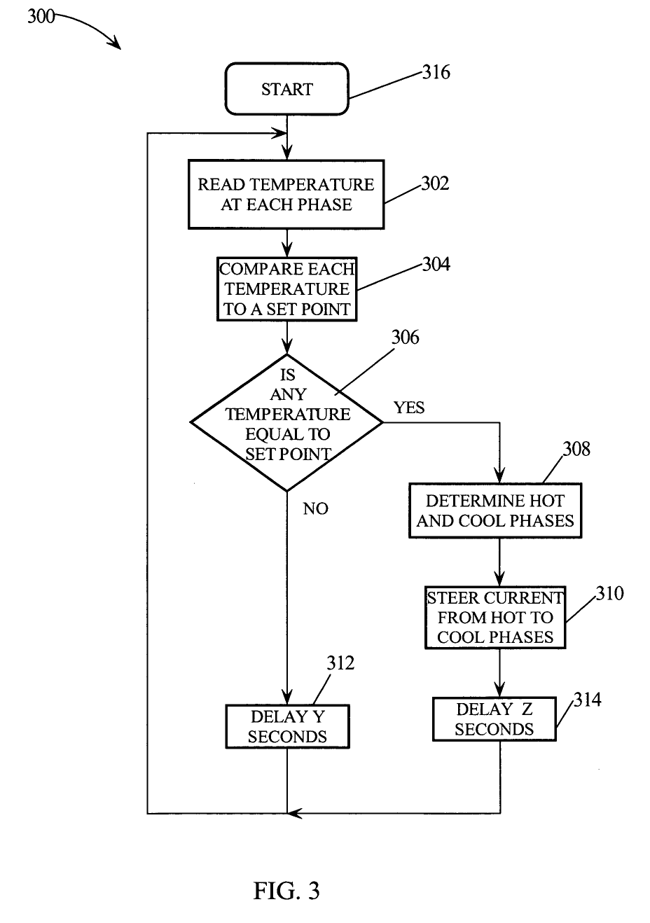

FIG. 3 illustrates representative steps taken by an embodiment of the present invention. In step 316, the system is started and in step 302 the temperature of each phase is measured. The temperature of a phase may be measured by a thermistor located in close proximity to the bank of FETs for that phase. FIG. 2 illustrates banks of FETs as items 210 and 208. Items 210 and 208 each represent banks of FETs and associated components for powering each phase of the voltage regulator circuit. Because of switching and conduction losses within the FETs of items 210 and 208, these areas tend to be the hottest in the voltage regulator circuit. Therefore, for purposes of measuring the temperature of the voltage regulator in step 302 of FIG. 3, the FETs 210 and 208 provide an optimal point for placement of temperature transducers. In step 304, the temperature of each phase is compared to a critical temperature or set point. A critical temperature can be a temperature known to cause damage to some circuit components and reduced reliability of other components. A set point could be a temperature below the critical temperature. In step 306, a determination is made whether a temperature of a phase is within the limits for safe operation. In step 306, if the temperature is not equal or greater than the set point, the system implements a delay in step 312 and the system cycles to step 302 for more temperature readings. If step 306 determines that the temperature of a phase is equal or greater than a set point, then in step 308 the system determines the highest difference between phase temperatures. In step 310, the system can steer current from the hottest to the coolest phase. Steering current from the hottest phase reduces the rate at which the hottest phase produces heat. After steering current from the hottest to the coolest phase, the system delays in step 314 for a period and then restarts the reading of temperatures in step 302. If a temperature is not equal to a set point in step 306, then step 312 delays fory seconds and then step 302 is repeated.

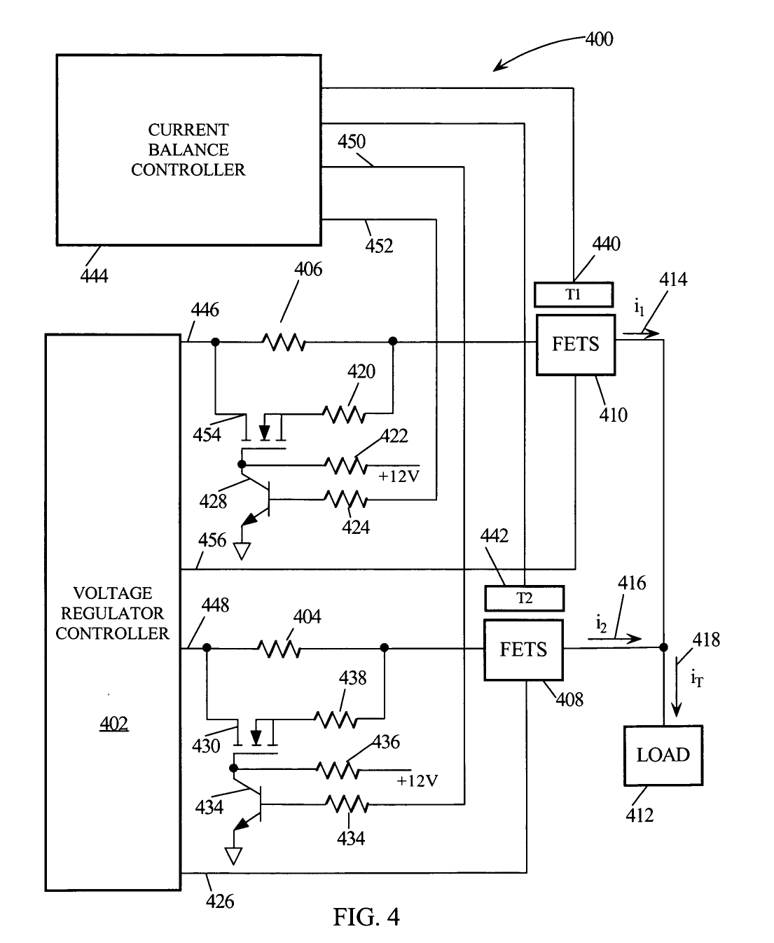

FIG. 4 illustrates a schematic of a voltage regulator 400 which is an embodiment of the invention. Voltage regulator 400 could be configured such as voltage regulator 102 for powering CPU 106 as shown in FIG. 1. The system in FIG. 4 includes a voltage regulator controller 402 for producing currents 416 and 414 to combine into current 418 for load 412. The circuit in FIG. 4 includes additional elements in parallel with sense resistors 404 and 406 for adjusting the effective resistance of the sense resistors which provide feedback to voltage regulator controller 402. Adjusting the effective value of the sense resistor providing feedback to voltage regulator controller 402 provides a way of increasing or decreasing current 414 or current 416 while still achieving the desired current 418 for load 412. Temperature transducers 440 and 442 provide current balance controller 444 with signals representing the temperatures of FETs 410 and 408. Items 440 and 442 could be thermistors which provide variable resistances based on the temperatures of FETs 410 and 408. Current balance controller 444 compares the temperatures from transducers 440 and 442 and determines whether FETs 410 or 408 are close to a temperature known to cause damage to circuit components. If current balance controller 444 determines that FETs 410 or 408 are at or near a critical temperature, current balance controller 444 can adjust the levels from pins 450 and 452 to turn on or off transistors 454 or 430, which has the effect of adjusting the effective resistor values providing feedback through pins 446 and 448 to voltage regulator controller 402. If transistor 430 is turned off, then the effective sense resistance of the second phase of the circuit is the value of resistor 404. However, if transistor 430 is turned on, then the effective sense resistance is determined by resistors 404 and 438 in parallel. If 404 and 438 have the same resistance value, then turning on transistor 430 would have the effect of cutting the effective sense resistance in half. Likewise, the effective sense resistance to pin 446 can be changed by toggling transistor 454. Current balance controller 444 can adjust the output level from pin 452 to turn on or off transistor 454. If transistor 454 is turned off, the effective sense resistance is just the value of resistor 406. However, if transistor 426 is turned on, the effective sense resistance to pin 446 is determined by taking the value of resistor 420 and the value of resistor 406 in parallel.

In the embodiment depicted in FIG. 4, transistor 428 is configured for controlling transistor 454. Resistor 422 is a pull-up resistor. Resistor 424 is a current limiting resistor for transistor 428. If current balance controller 444 outputs a low voltage from pin 452, the base of transistor 428 sees the low voltage and transistor 428 operates in cutoff mode. When transistor 428 operates in cutoff mode, transistor 454 essentially sees 12 volts at its gate. Transistor 454 is depicted in FIG. 4 as an N-channel enhancement mode field effect transistor from Fairchild Semiconductor, although other devices could be used in embodiments of the present invention. When the gate-source voltage of transistor 454 is forward biased, transistor 454 conducts current and the sense resistance in the feedback circuit to pin 446 is calculated essentially by adding resistor 406 and resistor 420 in parallel. The gate-source voltage of transistor 454 is forward biased when transistor 428 is turned off. When transistor 428 is turned on by applying a voltage signal from pin 452 of current balance controller 444, current conducts from the collector to the emitter of transistor 428 according to the operational characteristics including the β value of transistor 428. Depending on the value of resistor 424, the value of resistor 422, and the operational characteristics of transistors 428 and 454, the level of the voltage output from pin 452 can be adjusted to turn off transistor 454 and essentially remove resistor 420 from the sense resistor circuit by preventing current flow through transistor 454.

In the embodiment shown in FIG. 4, commonly known circuit elements are shown for varying the sense resistance in the feedback circuit to pins 446 and 448 of voltage regulator controller 402. For example, transistor 428 is shown as a NPN bipolar junction transistor. One of ordinary skill in the art will recognize that other elements can be used for varying the feedback signal to the voltage regulator controller. Further, a voltage regulator controller in another embodiment of the present invention may require feedback, for instance, by a digital signal or other means. The choices of circuit elements in FIG. 4 are not meant to limit claim scope to certain elements, and one of ordinary skill in the art will recognize other circuit elements for controlling currents 414 and 416. Although the foregoing analysis focuses on the phase of the multiphase voltage regulator for producing current 414, the same analysis can be applied to the phase that produces current 416. Also, one of ordinary skill in the art can easily calculate values for resistors 406, 420, 422, 424 and likewise for resistors 404, 438, 436, 434 without undue experimentation for a particular application of the present invention. However, in an embodiment, resistors 406 and 404 could be 750 ohms, resistors 420 and 438 could be 7150 ohms, resistors 422 and 436 could be 47 Kohms, and resistors 424 and 434 could be 1 Kohms.

Therefore, current balance controller 444 can be used to sense the temperatures of FETs 410 and 408. Using these temperature values, the current balance controller 444 can turn on or off transistors 454 and 430 to affect the sense resistance values in the feedback circuits delivered to voltage regulator controller 402 through pins 446 and 448. If the temperature in FET 410 is determined to be at a critical level or set point, current balance controller 444 may cause current 416 to increase and current 414 to decrease in order to achieve the same current 418 while lessening the burden on the first phase of voltage regulator 400.

The example shown in FIG. 4 illustrates a voltage regulator with only two phases. The present invention is not limited to a voltage regulator with only two phases and can include voltage regulators with three or more phases. For purposes of simplification, FETs 410 and 408 have been shown in block form. One of ordinary skill in the art will understand that items 410 and 408 include one or more FET transistors and associated components for providing currents 414 and 416. Also, the subject matter of the claims is not limited to embodiments which use field effect transistors, as other types of transistors may be used. Current balance controller 444 is shown in block diagram form, but one of ordinary skill in the art will recognize that any microcontroller or similar device can be used for implementing the steps as shown in FIG. 3 for comparing phase temperatures, determining whether the phase temperatures are within a critical range, and adjusting the outputs from pins 450 and 452 to adjust the effective sense resistance seen by pins 446 and 448 of voltage regulator controller 402. For example, current balance controller 444 could be implemented by a programmable system on a chip device (PSoC) which is available from Cypress Semiconductor.

Although the present invention and its advantages have been described in detail, it should be understood that various changes, substitutions and alterations can be made herein without departing from the spirit and scope of the invention as defined by the appended claims.

What is claimed is:

1. A method for controlling a multiphase voltage regulator comprising the steps of:
sensing a first thermal energy level from a first component of the multiphase voltage regulator wherein the first component conducts a first current;
comparing the first thermal energy level to a first set point; and
automatically reducing the first current if the first thermal energy level is greater than the first set point.

2. The method of claim 1 further comprising the steps of:
sensing a second thermal energy level from a second component of the multiphase voltage regulator wherein the second component conducts a second current;
comparing the second thermal energy level to a second set point;
automatically increasing the second current if the first thermal energy level is greater than the first set point and the second thermal energy level is less than the second set point.

3. The method of claim 2 wherein the first component comprises a first bank of FETs and wherein the step of automatically reducing the first current comprises adjusting the electrical resistance in a first feedback circuit to a voltage regulator controller.

4. The method of claim 2 further comprising providing a combined electric current to a load wherein the combined electric current is a combination of the first electric current and the second electric current.

5. The method of claim 1 wherein the first component is a first transistor and wherein sensing the first thermal energy level comprises placing a thermistor in close proximity to the first transistor so that the temperature of the thermistor is affected by the first thermal energy level from the first transistor.

6. The method of claim 3 wherein adjusting the electrical resistance in the first feedback circuit comprises a current balance controller turning on a first control transistor, wherein the current balance controller is electrically coupled to the first control transistor, and wherein the current balance controller is electrically coupled to a temperature transducer for sensing the first thermal energy level from the first bank of FETs.

7. The method of claim 3 wherein the first feedback circuit comprises a first resistor in parallel with an in-series-combination of a second resistor and a first control transistor and wherein adjusting the electrical resistance in the first feedback circuit comprises turning on the first control transistor.

8. A voltage regulator comprising:
a first output phase for providing a first current wherein the first output phase comprises a first transistor;
a second output phase for providing a second current wherein the first current and second current combine to provide a total current to a load and wherein the second output phase comprises a second transistor;
a first controller for adjusting the first current based on a first feedback signal and for adjusting the second current based on a second feedback signal;
a first sensor for measuring the temperature of the first transistor;
a second sensor for measuring the temperature of the second transistor; and
a second controller operatively coupled to the first sensor and operatively coupled to the second sensor for determining whether the temperature of the first transistor is greater than a first set point and for determining whether the temperature of the second transistor is greater than a second set point, wherein the second controller automatically adjusts the first feedback signal to prompt the first controller to reduce the current in the first output phase, and wherein the second controller automatically adjusts the second feedback signal to prompt the first controller to increase the current in the second output phase if the temperature of the first transistor is greater than the first set point and the temperature of the second transistor is less than the second set point.

9. The voltage regulator of claim 8 wherein the load is a CPU for a data processing system.

10. The voltage regulator of claim 9 wherein the first sensor comprises a thermistor and wherein the second sensor comprises a thermistor.

11. The voltage regulator of claim 8 wherein the first sensor is located in proximity to the first transistor so that thermal energy from the first transistor is absorbed by the first sensor and wherein the second sensor is located in proximity to the second transistor so that thermal energy from the second transistor is absorbed by the second sensor.

12. The voltage regulator of claim 11 wherein the second controller automatically adjusts the first feedback signal by adjusting the electrical resistance of a portion circuitry operatively coupled to the first feedback signal.

13. The voltage regulator of claim 8 further comprising:
a third output phase for providing a third current wherein the total current to the load is a combination of the first current, second current, and third current, and wherein the third output phase comprises a third transistor; and
a third sensor for measuring the temperature of the third transistor wherein the second controller determines which of the first, second, and third transistors is the hottest and which of the first, second, and third transistors is the coolest and wherein the second controller automatically prompts the first controller to increase the current in the output phase of the coolest transistor and decrease the current in the output phase of the hottest transistor.

14. The voltage regulator of claim 13 wherein the first output phase comprises a plurality of transistors and wherein the first current is an output of the plurality of transistors.

15. The voltage regulator of claim 13 wherein the plurality of transistors are FETs.

16. A voltage regulator comprising:
a first output phase for providing a first current wherein the first output phase comprises a first current source, a first feedback signal, and a first temperature transducer;
a second output phase for providing a second current wherein the second output phase comprises a second current source, a second feedback signal, and a second temperature transducer;
a first controller operatively coupled to receive the first feedback signal and the second feedback signal, wherein the first controller is operatively coupled to control the first current and the second current, wherein the first controller adjusts the first current based on the first feedback signal, and wherein the first controller adjusts the second current based on the second feedback signal; and
a second controller operatively coupled to the first temperature transducer, operatively coupled to the second temperature transducer, operatively coupled to the first feedback signal, and operatively coupled to the second feedback signal wherein the second controller converts a first signal from the first temperature transducer into a first temperature and converts a second signal from the second transducer into a second temperature, wherein the second controller compares the first temperature to a first set point and compares the second temperature to a second set point, wherein the second controller adjusts the first feedback signal and the second controller adjusts the second feedback signal if the first temperature is greater than the first set point and the second temperature is less than the second set point, and wherein the first controller reduces first current and increases the second current.

17. The voltage regulator of claim 16 wherein the first current source comprises a plurality of field effect transistors.

18. The voltage regulator of claim 16 wherein the second controller adjusts the first feedback signal by varying the electrical resistance of a conductor through which the first feedback signal is carried.

19. The voltage regulator of claim 16 further comprising circuitry for combining the first current and the second current to provide a total current to a load wherein the total current remains constant despite reducing the first current and increasing the second current.

20. The voltage regulator of claim 16 wherein the first set point is equal to the second set point
